(19) United States
(12) Patent Application Publication
(10) Pub. No.: US 2018/0127011 A1
(43) Pub. Date: May 10, 2018

(54) WHEEL-STAGGERED STAIRWAY-CLIMBING VECHICLE

(71) Applicant: Onostar Technologies Co., Limited, Guangzhou, Guangdong (CN)

(72) Inventor: Weizhong Cai, Guangzhou, Guangdong (CN)

(21) Appl. No.: 15/563,944

(22) PCT Filed: Jul. 1, 2015
(86) PCT No.: PCT/CN2015/083016

§ 371 Date: Oct. 2, 2017

(30) Foreign Application Priority Data
Apr. 2, 2015 (CN) 20151051140.3

(51) Int. Cl. B62B 5/02; B62B 9/02

(52) U.S. Cl. CPC B62B 5/026; B62B 2203/10; B62B 9/02; B62B 5/023

(57) ABSTRACT

A wheel-alternate stair climbing cart at least has one row of wheels (preferably two or more rows of wheels). Each row comprises a plurality of wheels. Two adjacent groups of wheels are intersected. The total length formed by connecting axle centers of a plurality of wheels can at least cross a vertex of three steps. The wheels on the stair at least keep contact with a vertex of two steps. The present invention better solves the problem that a traditional cart is blocked when operating on the stair or is bumpy when moving, and has the advantages of strong weight loading capability, difficult wear and low manufacturing cost.

### CROSS REFERENCE OF RELATED APPLICATION

This is a U.S. National Stage under 35 U.S.C 371 of the International Application PCT/CN2015/083016, filed Jul. 1, 2015, which claims priority under 35 U.S.C. 119(a-d) to CN 201510151140.3, filed Apr. 2, 2015.

### BACKGROUND OF THE PRESENT INVENTION

### Field of Invention

The present invention relates to a wheel-alternate stair climbing cart, which is able to be freely, stably and smoothly operated on the stair or flat ground and has better weight loading capability.

### Description of Related Arts

When no elevator (for example, low buildings generally have no elevator) is available and goods need to be transported upstairs and downstairs, if the goods are transported by means of manpower, large labor amount is required and the labor is slow and strenuous. Thus, various stair climbing carts are designed. But the existing stair climbing carts on the market have many defects, which are not be able to be accepted by users or popularized.

For example, a common stair climbing cart of which three or four small wheels surround a rotating shaft almost unable to be smoothly operated on the stair, is seriously bumpy during operation and especially unable to conveniently cross the higher or lower stairs or is bumpy more seriously. That is, the stair climbing capability is limited. Due to small wheels for weight loading, the weight loading capability is certainly small.

A crawler-type stair climbing cart is also designed, but the gap between the wheels is not really eliminated by this mode and this cart is still bumpy while moving on the stair. Moreover, the crawler belt is easily damaged and has poor weight loading capability.

### SUMMARY OF THE PRESENT INVENTION

The purpose of the present invention is to provide a stair climbing cart, which is able to be freely, smoothly and lightly operated on the stair and has better weight loading capability.

To realize the above technical solution, the present invention provides a wheel-alternate stair climbing cart which at least has one row of wheel sets (has two or more rows of wheel sets is better). Each row comprises a plurality of wheel sets. Two adjacent wheel sets are intersected. The total length formed by connecting axle centers of a plurality of wheel sets is able to at least cross vertexes of three steps. The wheels on the stair at least keep contact with vertexes of two steps.

Adjacent wheels are intersected (namely, the external diameters of the wheels are intersected from the perspective of a side view), so that the wheels is not able to be blocked by the steps when moving on the stair (because the wheels are intersected, no gaps are below the wheels).

The sizes of the wheels of the wheel sets can be adjusted properly and the wheels are adjustable in size and number. But the total length formed by all the wheels can at least cross the vertexes of three steps so as to ensure that the cart always at least keeps contact with the vertexes of two steps while operating on the stair for achieving that parallel straight lines are formed by two points on the vertex of the steps of the stair and two points in the wheels, so that the stair climbing cart is smooth during climbing, thereby solving the current situation that the stair climbing cart in the prior art is greatly bumpy when climbing the stair.

Compared with the prior art, the present invention better solves the problem of that a traditional cart is blocked while operating on the stair or is bumpy while moving, and has the advantages of strong weight loading capability, wear-resistant and low manufacturing cost.

### BRIEF DESCRIPTION OF THE DRAWINGS

To more clearly describe the technical solutions in the embodiments of the present to invention or in the prior art, the drawings required to be used in the description of the embodiments or the prior art will be simply presented below. Obviously, the drawings in the following description are merely some embodiments of the present invention and for those skilled in the art, other drawings is able to also be obtained according to the drawings without contributing creative labor.

FIG. 1 is a perspective view of an alternate stair climbing cart which shows the working principle of the present invention; and

FIG. 2 is a schematic diagram of a plane structure of an alternate stair climbing cart provided by the present invention.

### DETAILED DESCRIPTION OF THE PREFERRED EMBODIMENT

The technical solutions in the embodiments of the present invention will be clearly and fully described below with combination of the drawings in the embodiments of the present invention. Obviously, the described embodiments are merely part of the embodiments of the present invention, not all of the embodiments. Based on the embodiments in the present invention, all other embodiments obtained by those skilled in the art without contributing creative labor will belong to the protection scope of the present invention.

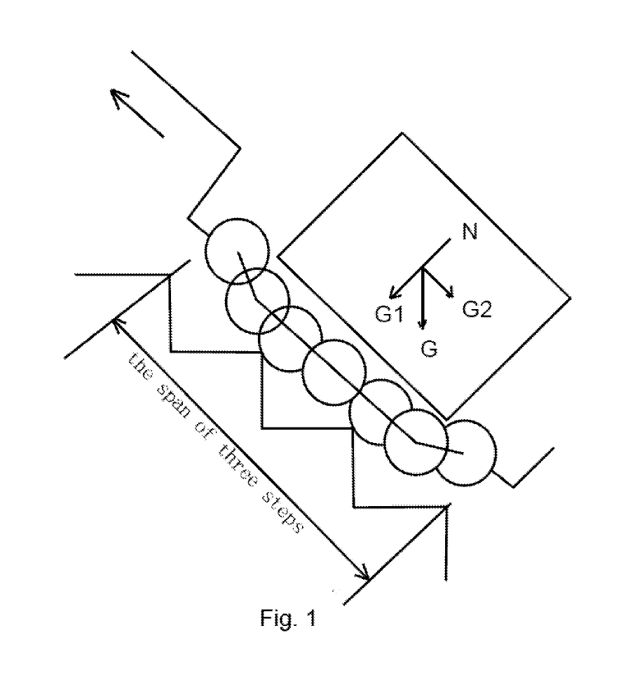

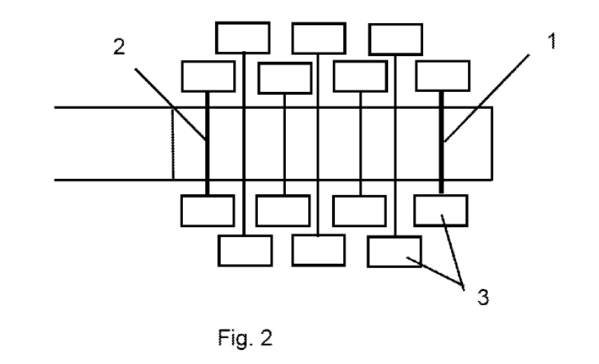

As shown in FIGS. 1-2, the stair climbing cart provided by the present invention at least has one row of wheels. Each row of wheels comprises a plurality of wheel sets. Two adjacent wheel sets are intersected. The first wheel set 1 and the last wheel set 2 in a plurality of wheel sets are curled up. The wheel axle of the last pair of wheel sets is thicker than that of other wheel sets. The wheel set refers to two wheels on both ends of the same axle.

As shown in FIGS. 1-2, the stair climbing cart provided by the present invention has a left and a right row of wheels. Each row comprises a plurality of wheels. Except a head wheel set and a tail wheel set, adjacent wheels 3 in any two adjacent sets are intersected (namely, the projections of the external diameters of the wheels are intersected). The total length formed by all the wheels can cross the vertexes of three steps. The first pair of wheels and the last pair of wheels are slightly curled up. The wheel axle of the last pair of wheels is thicker relatively.

As shown in FIGS. 1-2, in the process of climbing the stair, the motion track of the stair climbing cart is a micro wavy curve formed along the bottom of numerous wheels for operation. The cart is smoothly operated (the smooth degree is affected by the gap size between the wheels; the gap size is in direct proportion to the wheel center distance and in inverse proportion to the wheel radius; and the size and the number of the wheels is able to be determined according to applied actual demands). Further, a main body (frame) of the stair climbing cart provided by the present invention is able to be set as a telescopic structure so as to adapt to the requirements of different stair spans through the adjustment of length of the cart body.

From the force analysis, the stair climbing cart and the carried heavy objects are subject to the action of gravity; the gravity is decomposed into the pressure on the stair and downward sliding force along the stair. Meanwhile, the stair also generates supporting force on the cart, and the supporting force and the pressure decomposed from the gravity on the stair are offset. When the stair climbing cart is used, upward force along the stair is exerted thereon, so as to operate the stair climbing cart on the stair, thereby saving labor. But when the stair climbing cart is operated on the flat ground, because the cart always keeps one or more pairs of wheels on the ground, the cart can be operated only with push-pull force without lifting force, thereby also saving labor.

The designation of the stair climbing cart is related to the purpose. Different structures shapes and requirements are demanded in different applications. Human features shall be considered so that the stair climbing cart is able to be used more conveniently. Auxiliary devices are added and some structures are changed so that the center of gravity is proper and the objects is able to be transported stably with less labor.

Based on the above requirements, the following necessary data are listed: general human height: 1.50-1.80 meters; general height from human hands to the ground: 0.55-0.75 meter; general half step length of people in walking: 0.33 meter; stair width: 1.2 meters (residence)-1.8 meters (public place); general height of each step of the stair: 0.10-0.20 meter (commonly 0.125 meter); general depth of each step: 0.25-0.35 meter (commonly 0.315 meter); and span length of the vertex of three steps: 0.5-0.7 meter.

Based on the above data, the appropriate length of the stair climbing cart is more than 1.2 meters, wherein the total length formed by a plurality of groups of wheels must be greater than 0.7 meter. If the wheel diameter is 0.12 meter and the distance between the centers of adjacent wheels is 0.1 meter, at least 7 pairs of wheels are needed. Of course, the above sizes are not fixed and is able to be adjusted according to practical situations and application.

The wheel-alternate stair climbing cart provided by the present invention enables the transporting of the heavy objects upstairs and downstairs conveniently, which saves labor. In addition, the structure can also be used for wheelchairs, sports utility vehicles, tanks, etc.

The above is just preferred embodiments of the present invention and is not intended to limit the present invention. Any modification, equivalent replacement, improvement, etc. made within the spirit and the principle of the present invention shall be contained within the protection scope of the present invention.

What is claimed is:

1. A wheel-alternate stair climbing cart, comprising:
one or more rows of wheels, wherein each row of the wheels comprises multiple wheel sets; every two of adjacent wheel sets are intersected; a length of a line connecting an axis of a head wheel set and an axis tail set crosses three or more vertexes of stair steps; the wheel sets remain contacting with two or more vertexes of the stair steps.

2. The wheel-alternate stair climbing cart, as recited in claim 1, wherein the head wheel set and the tail wheel set of the multiple wheel sets are curved upward.

3. The wheel-alternate stair climbing cart, as recited in claim 1, wherein the axis of the tail wheel set is thicker than any other of the multiple wheel sets.
